(19) United States
(12) Patent Application Publication
(10) Pub. No.: US 2026/0093575 A1
(43) Pub. Date: Apr. 2, 2026

(54) SUBSTRATE DEFECT TROUBLESHOOTING ANALYSIS USING MACHINE LEARNING

(71) Applicant: Applied Materials, Inc., Santa Clara, CA (US)

(72) Inventors: Jeffrey Ryan Collins, San Jose, CA (US); Hexuan Wang, Fremont, CA (US); Abhinav Kumar, Milpitas, CA (US); Bhaskar Kumar, San Jose, CA (US); Qinyi Chen, San Jose, CA (US); Martin Jay Seamons, San Jose, CA (US); Ganesh Balasubramanian, Fremont, CA (US)

(21) Appl. No.: 18/904,758

(22) Filed: Oct. 2, 2024

(51) Int. Cl. G06F 11/07

(52) U.S. Cl. CPC G06F 11/0793; G06F 11/079

(57) ABSTRACT

A method includes obtaining, by a processing device, defect data for a substrate processed in a substrate processing system. The method further includes obtaining, by the processing device, context data associated with the substrate. The method further includes determining a troubleshooting guide associated with the defect data. The troubleshooting guide includes a sequence of troubleshooting operations, each associated with one or more probably root causes for the defect data. The method further includes determining a subset of context data based on the troubleshooting guide. The method further includes processing the defect data and the subset of context data using one or more trained machine learning models that output a predicted corrective action associated with a troubleshooting operation in the sequence of troubleshooting operations. The method further includes initiating the corrective action.

### TECHNICAL FIELD

The present disclosure relates to methods associated with substrate defect troubleshooting analysis procedures. Specifically, the present disclosure relates to methods associated with substrate defect troubleshooting analysis using machine learning.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. In some cases, products are produces that have defects. Minimizing defects or correcting defect root causes improves manufacturing reliability.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes obtaining, by a processing device, defect data for a substrate processed in a substrate processing system. The method further includes obtaining, by the processing device, context data associated with the substrate. The method further includes determining a troubleshooting guide associated with the defect data. The troubleshooting guide includes a sequence of troubleshooting operations, each associated with one or more probable root causes for the defect data. The method further includes determining a subset of context data based on the troubleshooting guide. The method further includes processing the defect data and the subset of context data using one or more trained machine learning models that output a predicted corrective action associated with a troubleshooting operation in the sequence of troubleshooting operations. The method further includes initiating the corrective action.

In another aspect of the present disclosure, a non-transitory machine-readable storage medium stores instructions which, when executed by a processing device cause the processing device to perform operations. The operations include obtaining defect data for a substrate processing in a substrate processing system. The operations further include obtaining context data associated with the substrate. The operations further include determining a troubleshooting guide associated with the defect data. The troubleshooting guide includes a sequence of troubleshooting operations, each associated with one or more probably root causes for the defect data. The operations further include determining a subset of context data based on the troubleshooting guide. The operations further include processing the defect data and the subset of context data using one or more trained machine learning models that output a predicted corrective action associated with a troubleshooting operation in the sequence of troubleshooting operations. The operations further include initiating the corrective action.

In a further aspect of the present disclosure, a system includes memory and a processing device operatively coupled with the memory. The processing device is configured to obtain defect data for a substrate processed in a substrate processing system. The processing device is further configured to obtain context data associated with the substrate. The processing device is further configured to determine a troubleshooting guide associated with the defect data. The troubleshooting guide includes a sequence of troubleshooting operations, each associated with one or more probably root causes for the defect data. The processing device is further configured to determine a subset of context data based on the troubleshooting guide. The processing device is further configured to process the defect data and the subset of context data using one or more trained machine learning models that output a predicted corrective action associated with a troubleshooting operation in the sequence of troubleshooting operations. The processing device is further configured to initiated the corrective action.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts a block diagram of a system including an example data set generator for creating data sets for one or more supervised models, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for generating and utilizing predicted corrective action data, according to some embodiments.

FIG. 5 depicts a data flow in association with operation of a defect troubleshooting analysis system, according to some embodiments.

FIGS. 6A-C depict exemplary user interfaces, according to some embodiments.

FIG. 7 is a block diagram illustrating a computer system, according to some embodiments.

### DETAILED DESCRIPTION

Described herein are technologies related to a method of defect troubleshooting analysis in substrate manufacturing systems, particularly with the use of machine learning.

Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point. In some embodiments, one or more substrates processed by the manufacturing equipment may include defects. Correcting root causes of defects, such as by performing corrective actions, may be a source of significant effort and expense at a manufacturing facility.

A variety of root causes may be related to defects of a substrate. In some cases, a defect may be caused by a combination of factors, or multiple causes may be potentially related to a single type of defect. In other cases, a single root cause may be associated with multiple defect modes, multiple types of defects, or the like.

A variety of data types, data sources, data signatures, and the like may be indicative of a root cause of one or more defects, a defect generation mode, or the like. Data describing one or more defects of a substrate may be diagnostic of defect root causes. Contextual data, which includes hardware data, recipe data, troubleshooting guide data, etc., may further be used in determining root causes. Data indicative of hardware (e.g., of one or more components of the manufacturing equipment) may be diagnostic of defect root causes. Recipe data may be diagnostic of defect root causes.

Data describing defects may include multiple data types or sources. Defect images may be used to classify defects and perform root cause analysis. Various features of defects may be discerned based on defect images. For example, defect size, defect shape, defect texture, defect regularity, along with many other defect features may be determined based on one or more defect images. Each of these features extracted from one or more defect images of the defect may indicate one or more potential root causes for defect formation. Defect height may be measured and utilized in determining root causes. Defect composition may be measured and utilized in determining root causes. Defect classification, defect location, and defect spatial signature may additionally be utilized in determining root causes.

Contextual data, e.g., data contributing to a defect but not a result of measurement of the defect, may be used for determining or predicting defect root causes. Data indicative of hardware, used to determine or predict defect root causes, may include identifying data, such as data identifying manufacturing facilities, tools, chambers, or the like. Hardware data may further include indications of components included in manufacturing equipment, such as identifiers of component models, component manufacturing batches, or the like. Process data may also be used in determining defect root causes. Process data may include recipe data. Process data may include seasoning data, e.g., data indicative of various materials, coatings, or the like present in a process chamber. Process data may include chemistry data, e.g., indications of interactions between process gases, substrate material, coating material, chamber wall or other component material, plasma byproducts, deposition or etch byproducts, or other materials that may induce relevant chemistry in the process chamber.

In some embodiments, troubleshooting guides may be used for determining or predicting corrective actions for mitigating defects. Data indicative of a sequence of troubleshooting operations may be used for determining instances of contextual data that are relevant for determining or predicting corrective actions. In some embodiments, a troubleshooting guide is a flow chart created for the purpose of troubleshooting substrate defects, such as for correcting the defect by performing a sequence of troubleshooting operations, etc. In some embodiments, a troubleshooting guide includes multiple checks (e.g., troubleshooting operations, etc.) that an engineer or technician is to perform. Each of the checks may be associated with one or more probable root causes for the defect. Based on the results of each of the performed checks, the troubleshooting guide may indicate further checks and/or a corrective action which, when performed, may correct for the substrate defect. In some embodiments, a troubleshooting guide includes a plurality of corrective actions associated with a corresponding plurality of substrate defects. By following the sequence of checks, a corrective action can be determined using the troubleshooting guide. A troubleshooting guide may be used to determine a subset of the contextual information useful for troubleshooting the defect.

Conventionally, without the use of established troubleshooting guides, engineers and/or technicians may spend much time troubleshooting substrate defects. Often, access to historical defect data is limited, so engineers and/or technicians may rely on their own expertise and experience in troubleshooting substrate defects to find a root cause and corresponding corrective action. Engineers and/or technicians that have little experience, however, may have difficulty properly troubleshooting defects and may rely on more senior engineers and/or technicians to troubleshoot any defects. This can impose a cost to efficient operations in a substrate processing facility.

Aspects of the present disclosure may address one or more shortcomings of conventional defect troubleshooting methods. In some embodiments, an application for tracking and/or storing defect reduction efforts and/or projects is disclosed. In some embodiments, related defect classification and/or root cause analysis projects are linked together for effective troubleshooting of defects and determination of corrective actions for correcting the defects. Reports and/or timelines of the troubleshooting decisions made throughout the defect reduction process may be generated to save time for future engineers troubleshooting the same and/or similar defects. The defect reduction process may be accelerated and/or simplified for engineers according to embodiments described herein.

In some embodiments, one or more machine learning models are used to process data for prediction of a corrective action associated with a substrate defect. Defect data for a substrate processed in a substrate processing system may be obtained. In some embodiments, defect data may include defect image data, such as a number of defect features extracted from one or more images of the defect. Defect data may include further defect feature data, such as defect height data. Defect data may further include defect composition data. Defect data may further include spatial defect signature data, e.g., a signature of a distribution of defect locations across a substrate. Defect data may further include defect classification data.

Context data associated with the substrate may be obtained. Context data may be included in data provided to the defect analysis system. Context data may include identifying data of a process chamber, such as a chamber identification, tool identification, manufacturing facility identification, or the like. Context data may include identifying data of hardware components, such as an indication of included hardware components, component age, component health, etc. Context data may include process data, such as process recipe data, including process gas data, process temperature data, process plasma properties, or the like. Context data may include seasoning data, e.g., chamber condition data, chamber coating data, chamber maintenance history data, or the like. Context data may include chemistry data, e.g., data indicative of materials of the chamber, materials introduced in a process, process byproduct chemistry, substrate material chemistry, and the like.

A troubleshooting guide associated with the defect data may be determined. In some embodiments, a user (e.g., an engineer, a technician, etc.) may select the troubleshooting guide from a plurality of troubleshooting guides. The troubleshooting guide may include a sequence of troubleshooting operations, each associated with one or more probable root causes for the defect data. For example, a troubleshooting guide may include a sequence of checks for checking probable root causes for defects indicated in the obtained defect data.

A subset of context data may be determined based on the troubleshooting guide. In some embodiments, context data that is not relevant to the troubleshooting guide may be excluded. For example, where the selected troubleshooting guide is for gas flow, context data associated with radio frequency (RF) power in the processing chamber may be excluded. The determined subset of context data may be data that is relevant to the troubleshooting guide. Continuing with the above example, where the selected troubleshooting guide is for gas flow, context data associated with the flow of gas into and/or out of the process chamber may be determined to be relevant.

The defect data and/or the subset of context data is input into one or more trained machine learning models that output a predicted corrective action associated with a troubleshooting operation in the sequence of troubleshooting operations of the troubleshooting guide. In some embodiments, the one or more trained machine learning models includes a first trained machine learning model trained to output a predicted root cause and a second trained machine learning model trained to output a predicted corrective action. The defect data and/or the subset of the context data may be input into the first trained machine learning model. The first trained machine learning model may output a predicted root cause associated with the defect data and the context data. For example, the first trained machine learning model may output a predicted root cause for a defect indicated in the defect data and based on the subset of context data. At least the predicted root cause may be input into the second trained machine learning model. The second trained machine learning model may output the predicted corrective action. In some embodiments, the second trained machine learning model is trained with training input data including historical defect data and historical context data and trained with training output data including historical predicted root cause data.

The predicted corrective action output from the one or more trained machine learning models may be initiated. In some embodiments, an indication of the corrective action may be output for display on a graphical user interface (GUI), such as for viewing by a user (e.g., an engineer or technician, etc.). In some embodiments, an alert is provided to a user (e.g., via a GUI) indicative of the corrective action. The corrective action may be initiated. In some embodiments, initiating the corrective action includes updating software (e.g., control software, etc.) for the substrate processing system to correct the defect. In some embodiments, initiating the corrective action includes initiating seasoning operations, initiating cleaning operations, scheduling maintenance or replacement of components, one or more maintenance operations for a process chamber, or the like.

Aspects of the present disclosure provide technological improvements over conventional methods. By providing defect data and contextual data to one or more machine learning models for troubleshooting substrate defects and initiating a predicted corrective action output from the one or more machine learning models, efficiency of defect troubleshooting can be increased. Accordingly, costs (e.g., time costs, etc.) associated with defect troubleshooting can be reduced. Reduction of costs may include reduced time used for experimentation and/or reduced human costs. For example, engineers and/or technicians can use the systems and/or methods described herein rather than using undue experimentation or consulting with other engineers or technicians, etc. Use of the systems and/or methods described herein may provide more expeditious defect troubleshooting, which may provide for quicker correction of defects. Accordingly, more substrates meeting a target specification (e.g., lacking defects, etc.) may be produced in a shorter period of time, increasing overall system throughput.

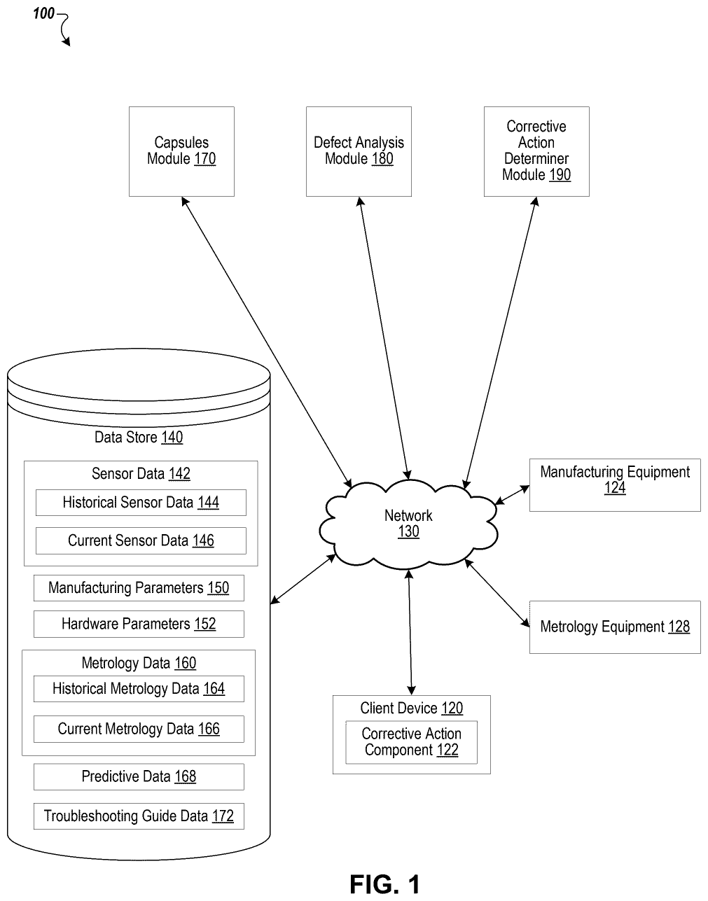

FIG. 1 is a block diagram illustrating an exemplary system 100 (exemplary system architecture), according to some embodiments. The system 100 includes a client device 120, manufacturing equipment 124, metrology equipment 128, capsules module 170, defect analysis module 180, corrective action determine module 190, and data store 140.

Manufacturing equipment 124 may be or include a combination of hardware components for performing substrate processing operations. Manufacturing equipment 124 may include one or more process chambers, which may be designed and/or configured to perform various processing operation, e.g., etch operations, deposition operations, anneal operations, etc. Manufacturing equipment 124 may include one or more tools, e.g., mainframes including a number of process chambers for providing processing environments for multiple substrates, for performing different process operations, or the like. Manufacturing equipment 124 may include one or more manufacturing facilities, e.g., including a number of process tools or process chambers for manufacturing substrates (such as semiconductor wafers).

Manufactured substrates may be processed for a target use or application. Manufactured substrates may exhibit properties dependent upon processing procedures and process conditions used in manufacturing the substrates. Substrates may have property values (film thickness, film strain, feature size, image data, defect data, etc.) measured by metrology equipment 128, e.g., measured at a standalone metrology facility. Metrology data 160 measured by metrology equipment 128 may be stored in data store 140. Metrology data 160 may include historical metrology data 164 (e.g., metrology data associated with previously processed products), and current metrology data 166 (e.g., data associated with one or more substrates of interest). Metrology data 160 may include measurements made by metrology equipment 128, analysis performed on the measurement data, output of one or more models associated with metrology equipment, or the like. For example, metrology data 160 may include images of defects, as well as measurements of the imaged defects extracted algorithmically from the images, as well as one or more image features extracted by a trained machine learning model from the defect images. Similarly, spectral data of a defect, along with data generated by analyzing the spectral data indicative of atomic composition of the defect, may be included in metrology data 160. Data measuring locations of a number of defects, as well as a classification of a general pattern of the defects, may be included in metrology data 160. Measurements of a defect, as well as a defect classification (e.g., generated by a trained machine learning model) may be included in metrology data 160.

In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data 166 (e.g., metrology data associated with a product currently or recently processed).

Data store 140 may include manufacturing parameters 150. Manufacturing parameters 150 may include indications of process conditions utilized in processing one or more substrates. Manufacturing parameters 150 may include data indicative of process recipes. Manufacturing parameters 150 may include property set points, utilized by manufacturing equipment 124 in managing process conditions in association with processing one or more substrates Data store 140 may further include hardware parameters 152. Hardware parameters 152 may include data indicative of installed components of manufacturing equipment 124, history of manufacturing equipment 124, performance of manufacturing equipment 124, or the like. For example, identification of process chambers, tools, or facilities may be included in hardware parameters 152. Indications of chamber maintenance history, chamber seasoning or coating history or conditions, chamber materials and chemistry, or the like may be included in hardware parameters 152.

In some embodiments, troubleshooting guide data 172 is stored in data store 140. Troubleshooting guide data 172 may be indicative of multiple troubleshooting sequences that can be performed for the troubleshooting of substrate defects. Troubleshooting guide data 172 may include data for multiple troubleshooting guides. A troubleshooting guide may be selected (e.g., based on user input, such as via a GUI of client device 120). The selected troubleshooting guide may be for correction of a defect indicated in metrology data 160.

In some embodiments, metrology data 160, hardware parameters 152, troubleshooting guide data 17, or manufacturing parameters 150 may be processed (e.g., by the client device 120, by the capsules module 170, by the defect analysis module 180, and/or by the corrective action determiner module 190, etc.). Processing of the input data may include generating features. In some embodiments, the features are a pattern in the hardware parameters 152, metrology data 160, and/or manufacturing parameters 150 (e.g., slope, width, height, peak, etc.) or a combination of values from the hardware parameters, metrology data, and/or manufacturing parameters (e.g., power derived from voltage and current, etc.). The input data for processing may include features and the features may be used by the capsules module 170, by the defect analysis module 180, and/or by the corrective action determiner module 190 for performing signal processing and/or for obtaining predictive data 168 for performance of a corrective action.

Each instance (e.g., set) of metrology data 160 may correspond to a product (e.g., a substrate), one or a set of manufacturing equipment, a type of substrate produced by manufacturing equipment, or the like. Each instance of hardware parameters 152 and manufacturing parameters 150 may likewise correspond to a product, a set of manufacturing equipment, a type of substrate produced by manufacturing equipment, or the like. The data store may further store information associating sets of different data types, e.g. information indicative that a set of sensor data, a set of metrology data, and a set of manufacturing parameters are all associated with the same product, manufacturing equipment, type of substrate, etc.

In some embodiments, the capsules module 170, the defect analysis module 180, and/or the corrective action determiner module 190 may generate predictive data 168 using supervised machine learning (e.g., predictive data 168 includes output from a machine learning model that was trained using labeled data. In some embodiments, the capsules module 170, the defect analysis module 180, and/or the corrective action determiner module 190 may generate predictive data 168 using unsupervised machine learning (e.g., predictive data 168 includes output from a machine learning model that was trained using unlabeled data, output may include clustering results, principle component analysis, anomaly detection, etc.). In some embodiments, the capsules module 170, the defect analysis module 180, and/or the corrective action determiner module 190 may generate predictive data 168 using semi-supervised learning (e.g., training data may include a mix of labeled and unlabeled data, etc.).

Client device 120, manufacturing equipment 124, sensors 126, metrology equipment 128, capsules module 170, defect analysis module 180, and/or corrective action determiner module 190 may be coupled to each other via network 130 for generating predictive data 168 to perform corrective actions. In some embodiments, network 130 may provide access to cloud-based services. Operations performed by client device 120, capsules module 170, defect analysis module 180, corrective action determiner module 190, data store 140, etc., may be performed by virtual cloud-based devices.

In some embodiments, network 130 is a public network that provides client device 120 with access to capsules module 170, defect analysis module 180, corrective action determiner module 190, data store 140, and/or other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to capsules module 170, defect analysis module 180, and/or corrective action determiner module 190, receives output (e.g., predictive data 168) from capsules module 170, defect analysis module 180, and/or corrective action determiner module 190, and causes a corrective action to be implemented. In some embodiments, corrective action component 122 obtains data associated with manufacturing equipment 124 (e.g., from data store 140, etc.) and the data associated with the manufacturing equipment 124 to capsules module 170, defect analysis module 180, and/or corrective action determiner module 190.

In some embodiments, corrective action component 122 receives an indication of a corrective action from capsules module 170, defect analysis module 180, and/or corrective action determiner module 190 and causes the corrective action to be initiated and/or implemented. Each client device 120 may include an operating system that allows users to one or more of generate, view, or edit data (e.g., indication associated with manufacturing equipment 124, corrective actions associated with manufacturing equipment 124, etc.). A client device 120 may provide alerts to one or more users, e.g., via a user interface (such as a graphical user interface). Client device 120 may be used by a user to provide information or instructions to system 100. For example, a user may provide feedback on the accuracy of predictive data 168. The provided feedback may then be incorporated into system 100 by updating parameters of one or more models of capsules module 170, defect analysis module 180, and/or corrective action determiner module 190, adjusting operations of a predictive component of capsules module 170, defect analysis module 180, and/or corrective action determiner module 190 to improve performance or accuracy, or the like.

In some embodiments, metrology data 160 (e.g., historical metrology data 164) corresponds to historical property data of products (e.g., products processed using manufacturing parameters associated with historical hardware parameters 152 and historical manufacturing parameters of manufacturing parameters 150) and predictive data 168 is associated with predicted root causes of substrate defects and/or predicted corrective actions associated with the predicted root causes, etc. In some embodiments, predictive data 168 is or includes an indication of any abnormalities (e.g., abnormal products, abnormal components, abnormal manufacturing equipment 124, abnormal energy usage, etc.), one or more causes of the abnormalities, and/or one or more corrective actions for the causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like. In some embodiments, predictive data 168 is an indication of a recommended plan for addressing defect root causes of manufacturing equipment 124, e.g., a partition plan.

Performing manufacturing processes that result in defective products can be costly in time, energy, products, components, manufacturing equipment 124, the cost of identifying the defects and discarding the defective product, etc. In some embodiments, sensor data 142, manufacturing parameters 150 (e.g., manufacturing parameters that are being used or are to be used to manufacture a product) and/or metrology data 160 is input into capsules module 170, defect analysis module 180, and/or corrective action determiner module 190. In some embodiments, predictive data 168 is received as output. In some embodiments, a corrective action is initiated based on the predictive data 168. Therefore, system 100 can have the technical advantage of avoiding the cost of producing, identifying, and discarding defective products.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting data associated with substrate defects (e.g., manufacturing parameters 150, hardware parameters 152, metrology data 160, etc.) to capsules module 170, defect analysis module 180, and/or corrective action determiner module 190, a corrective action of updating manufacturing parameters (e.g., setting optimal manufacturing parameters), system 100 can have the technical advantage of using optimal manufacturing parameters (e.g., hardware parameters, process parameters, optimal design) to avoid costly results of suboptimal manufacturing parameters, such as reducing a rate of defect occurrence.

Corrective actions may be associated with one or more of preventive operative maintenance, corrective maintenance, design optimization, updating of manufacturing parameters, updating manufacturing recipes, feedback control, machine learning modification (e.g., updating one or more parameters of a trained machine learning model), or the like.

Hardware parameters 152 may include information indicative of which components are installed in manufacturing equipment 124, indicative of component replacements, indicative of component age, indicative of software version or updates, etc. Manufacturing parameters 150 may include process parameters such as temperature, pressure, flow, rate, electrical current, voltage, gas flow, lift speed, etc. In some embodiments, the corrective action includes causing preventive operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., altering the timing of manufacturing subsystems entering an idle or active mode, altering set points of various property values, etc.).

Capsules module 170, defect analysis module 180, and/or corrective action determiner module 190 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of capsules module 170, defect analysis module 180, and/or corrective action determiner module 190, data store 140, etc., may be performed by a cloud computing service, cloud data storage service, etc.

Capsules module 170, defect analysis module 180, and/or corrective action determiner module 190 may each include a predictive component. In some embodiments, the predictive component may receive data of interest (e.g., manufacturing parameters 150, hardware parameters 152, current metrology data 166, troubleshooting guide data 172, etc.), and generate output (e.g., predictive data 168) for performing corrective action associated with the manufacturing equipment 124 based on the current data. In some embodiments, predictive data 168 may include predicted defect root causes and/or predicted corrective actions, in connection with one or more defects represented in current metrology data 166.

Manufacturing equipment 124 may be associated with one or more machine leaning models, e.g., of one or more of capsules module 170, defect analysis module 180, and/or corrective action determiner module 190. Machine learning models associated with manufacturing equipment 124 may perform many tasks, including process control, classification, performance predictions, etc. The model may be trained using data associated with manufacturing equipment 124 or products processed by manufacturing equipment 124, e.g., manufacturing parameters 150 (e.g., associated with process control of manufacturing equipment 124), hardware parameters 152, metrology data 160 (e.g., generated by metrology equipment 128), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels associated with an image of a substrate including one or more defect; the first representational layer may abstract the pixels and encode edges; the second layer may compose and encode arrangements of edges; the third layer may encode higher level shapes (e.g., substrate defects, substrate defect shapes, etc.); and the fourth layer may perform a classification role, such as determining a type of defect in an image. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, a predictive component (e.g., of one or more of capsules module 170, defect analysis module 180, corrective action determiner module 190, etc.) receives hardware parameters 152, current metrology data 166, troubleshooting guide data 172, and/or current manufacturing parameters 150, performs signal processing to break down the current data into sets of current data and/or one or more features vectors associated with current data, provides the sets of current data and/or feature vectors as input to a trained machine learning model, and obtains outputs indicative of predictive data 168 from the trained machine learning model. In some embodiments, the predictive component may receive data indicative of one or more substrate defects (e.g., metrology data) and data indicative of context related to generation of those defects (e.g., associated hardware and manufacturing process parameters) and generate predictive defect root cause data and/or predictive corrective action data in view of the input defect and context data.

In some embodiments, capsules module 170, defect analysis module 180, and/or corrective action determiner module 190 may include a large number of models, each configured to perform different tasks. In some embodiments, one or more models may be configured to generate features, e.g., to make conclusions based on data from data store 140 (e.g., defect classification from defect data of metrology data 160, defect image features from defect images captured by manufacturing equipment 124, etc.). In some embodiments, features which may be generated by one or more machine learning models, algorithms, statistical models, rule-based models, or the like may be provided to further machine learning models. For example, output of a number of trained machine learning models may be provided to a further machine learning model of capsules module 170, defect analysis module 180, and/or corrective action determiner module 190 to determine or predict defect root causes, determine or predict corrective actions, and/or provide defect analysis, etc.

In some embodiments, the various models discussed in connection with capsules module 170, defect analysis module 180, and/or corrective action determiner module 190 may be combined in one model (e.g., an ensemble model), or may be separate models.

Data may be passed back and forth between several distinct models included in capsules module 170, defect analysis module 180, and/or corrective action determiner module 190. In some embodiments, capsules module 170 includes one or more models, etc. to analyze the troubleshooting guide data 172 and select a subset of manufacturing parameters 150, hardware parameters, sensor data 142, and/or metrology data 160 for providing to the defect analysis module 180 and/or to the corrective action determine module 190. In some embodiments, the defect analysis module 180 includes one or more models to analyze, identify, and/or predict defects, such as based on metrology data 160, sensor data 142, manufacturing parameters 150, and/or hardware parameters 152. Output from the one or more models of the defect analysis module 180 may be provided to the corrective action determine module 190. In some embodiments, the corrective action determiner module 190 includes one or more models to identify and/or predict root causes for the defects. Output from the one or more models of the corrective action determiner module 190 may be provided to the capsules module 170. In some embodiments, the capsules module 170 includes one or more models to identify and/or predict corrective actions for the root causes. In some embodiments, some or all of these operations may instead be performed by a different device. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store manufacturing parameters 150, metrology data 160, hardware parameters 152, predictive data 168, and/or troubleshooting guide data 172.

Historical metrology data 166, historical hardware parameters 152, and historical manufacturing 150 parameters may be or include historical data (e.g., at least a portion of these data may be used for training model(s) of capsules module 170, defect analysis module 180, and/or corrective action determine module 190, etc.). Current metrology data 166, current manufacturing parameters, and/or current hardware parameters may be current data (e.g., at least a portion to be input into learning model(s), subsequent to the historical data) for which predictive data 168 is to be generated (e.g., for performing corrective actions).

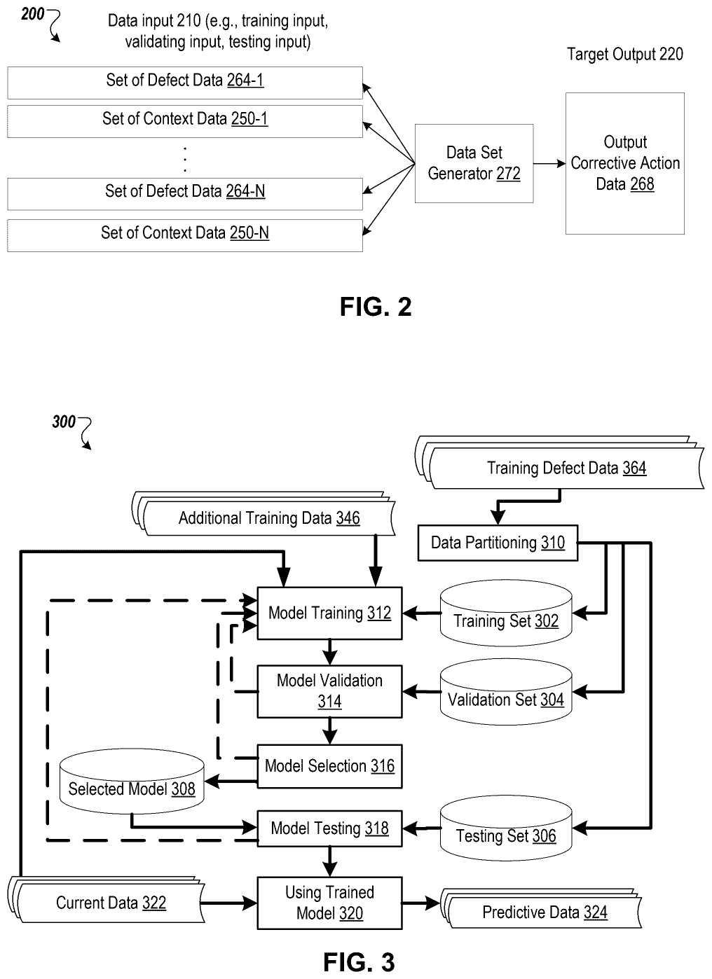

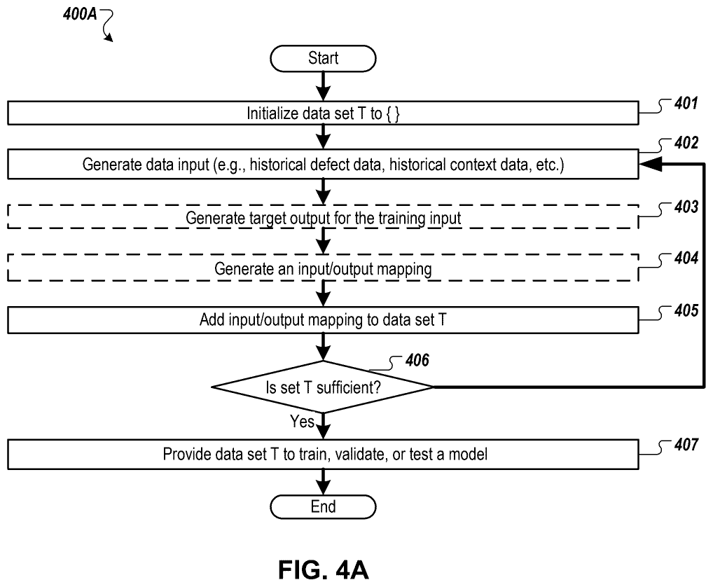

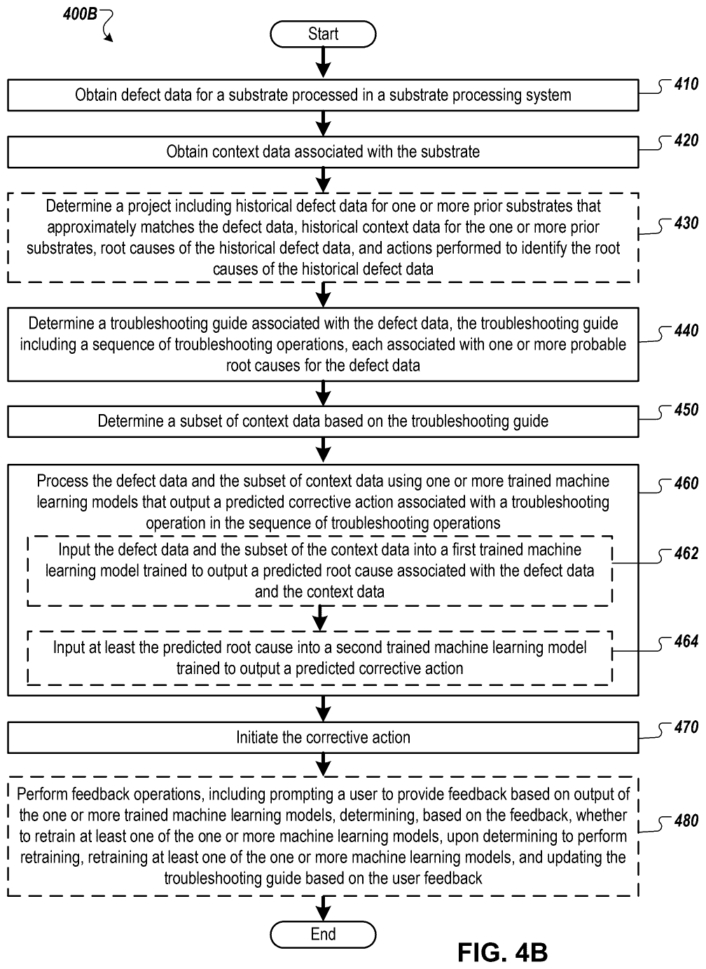

In some embodiments, capsules module 170, defect analysis module 180, and/or corrective action determiner module 190 include a data set generator that is capable of generating data sets (e.g., a set of data inputs and a set of target outputs) to train, validate, and/or test models, including one or more machine learning models. Some operations of the data set generator are described in detail below with respect to FIGS. 2 and 4A. In some embodiments, the data set generator may partition the historical data (e.g., historical manufacturing parameters, historical metrology data 164) into a training set (e.g., sixty percent of the historical data), a validating set (e.g., twenty percent of the historical data), and a testing set (e.g., twenty percent of the historical data).

In some embodiments, capsules module 170, defect analysis module 180, and/or corrective action determiner module 190 generates multiple sets of features. For example a first set of features may correspond to a first set of types of metrology data (e.g., metrology data from a first set of metrology tools, features output by one or more analysis modules based on metrology data, patterns in metrology data or metrology data analytics, etc.) that correspond to each of the data sets (e.g., training set, validation set, and testing set) and a second set of features may correspond to a second set of types of metrology data that correspond to each of the data sets.

In some embodiments, capsules module 170, defect analysis module 180, and/or corrective action determiner module 190 include a training engine, a validation engine, a selection engine, and/or a testing engine. An engine may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine may be capable of training a model (e.g., of capsules module 170, defect analysis module 180, and/or corrective action determiner module 190) using one or more sets of features associated with the training set from the data set generator. The training engine may generate one or more trained models (e.g., of capsules module 170, defect analysis module 180, and/or corrective action determiner module 190), where each trained model corresponds to a distinct set of features of the training set (e.g., sensor data from a distinct set of sensors). The data set generator may receive the output of a trained model (e.g., output of a model configured to classify or generate features based on metrology measurements), collect that data into training, validation, and testing data sets, and use the data sets to train a second model (e.g., a machine learning model configured to output predictive data, perform defect analysis, perform corrective actions, etc.).

The validation engine may be capable of validating a trained model using a corresponding set of features of the validation set from the data set generator. For example, a first trained machine learning model that was trained using a first set of features of the training set may be validated using the first set of features of the validation set. The validation engine may determine an accuracy of each of the trained models based on the corresponding sets of features of the validation set. The validation engine may discard trained models that have an accuracy that does not meet a threshold accuracy. In some embodiments, the selection engine may be capable of selecting one or more trained models that have an accuracy that meets a threshold accuracy. In some embodiments, the selection engine may be capable of selecting the trained model that has the highest accuracy of the trained models.

The testing engine may be capable of testing a trained model using a corresponding set of features of a testing set from the data set generator. For example, a first trained machine learning model that was trained using a first set of features of the training set may be tested using the first set of features of the testing set. The testing engine may determine a trained model that has the highest accuracy of all of the trained models based on the testing sets.

In the case of a machine learning model, a model may refer to the model artifact that is created by the training engine using a training set that includes data inputs and corresponding target outputs (correct answers for respective training inputs). Patterns in the data sets can be found that map the data input to the target output (the correct answer), and the machine learning model is provided mappings that capture these patterns. The machine learning model may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

In some embodiments, one or more machine learning models may be trained using historical data (e.g., historical metrology data 164). In some embodiments, models may have been trained using output of other models, such as portions of metrology data 160 that are output by an analysis model based on measurements of metrology equipment 128.

Capsules module 170, defect analysis module 180, and/or corrective action determiner module 190 may provide current data to a model and may run the model on the input to obtain one or more outputs. For example, capsules module 170, defect analysis module 180, and/or corrective action determiner module 190 may provide manufacturing parameters, hardware parameters, troubleshooting guide data 172, and/or metrology data to a model and may run the model on the input to obtain one or more outputs. Capsules module 170, defect analysis module 180, and/or corrective action determiner module 190 may be capable of determining (e.g., extracting) predictive data 168 from the output of the model. Capsules module 170, defect analysis module 180, and/or corrective action determiner module 190 may determine (e.g., extract) confidence data from the output that indicates a level of confidence that predictive data 168 is an accurate predictor of a process associated with the input data for products produced or to be produced using the manufacturing equipment 124. Capsules module 170, defect analysis module 180, corrective action determiner module 190, and/or corrective action component 122 may use the confidence data to decide whether to initiate a corrective action associated with the manufacturing equipment 124 based on predictive data 168.

The confidence data may include or indicate a level of confidence the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data, component health of components of manufacturing equipment 124, or a corrective action associated with the products and indicates absolute confidence that the predictive data 168 accurately predicts properties of products processed according to input data, component health of components of manufacturing equipment 124, or a corrective action associated with the products. Responsive to the confidence data indicating a level of confidence below a threshold level for a predetermined number of instances (e.g., percentage of instances, frequency of instances, total number of instances, etc.), capsules module 170, defect analysis module 180, and/or corrective action determiner module 190 may cause one or more trained machine learning models to be retrained. In some embodiments, user feedback (e.g., via client device 120) may cause one or more of the model(s) to be retrained. In some embodiments, retraining may include generating one or more data sets (e.g., via the data set generator) utilizing historical data.

For purpose of illustration, rather than limitation, aspects of the disclosure describe the training of one or more machine learning models using historical data and inputting current into the one or more trained machine learning models to determine predictive data 168. In other embodiments, a heuristic model, physics-based model, or rule-based model is used to determine predictive data 168 (e.g., without using a trained machine learning model). In some embodiments, such models may be trained using historical data. In some embodiments, these models may be retrained utilizing historical data. Capsules module 170, defect analysis module 180, and/or corrective action determiner module 190 may monitor historical data to determine changes to chamber condition, equipment condition, model accuracy, or the like. Any of the information described with respect to data inputs 210 of FIG. 2 may be monitored or otherwise used in the heuristic, physics-based, or rule-based model.

In some embodiments, the functions of client device 120, capsules module 170, defect analysis module 180, and/or corrective action determiner module 190 may be provided by a fewer number of machines. For example, in some embodiments, capsules module 170, defect analysis module 180, and/or corrective action determiner module 190 may be integrated into a single machine. In some embodiments, client device 120, capsules module 170, defect analysis module 180, and/or corrective action determiner module 190 may be integrated into a single machine. In some embodiments, functions of client device 120, capsules module 170, defect analysis module 180, corrective action determiner module 190, and/or data store 140 may be performed by a cloud-based service.

In addition, the functions of a particular component can be performed by different or multiple components operating together. One or more of the capsules module 170, defect analysis module 180, and/or corrective action determiner module 190 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

FIG. 2 depicts a block diagram of example data set generator 272 (e.g., a data set generator described above with respect to capsules module 170, defect analysis module 180, and/or corrective action determiner module 190 of FIG. 1) to create data sets for training, testing, validating, etc. a model (e.g., a model of capsules module 170, defect analysis module 180, and/or corrective action determiner module 190 of FIG. 1), according to some embodiments. Each data set generator 272 may be part of one of capsules module 170, defect analysis module 180, and/or corrective action determiner module 190 of FIG. 1. In some embodiments, several machine learning models associated with manufacturing equipment 124 may be trained, used, and maintained (e.g., within a manufacturing facility). Each machine learning model may be associated with one data set generator 272, multiple machine learning models may share a data set generator 272, etc.

FIG. 2 depicts a system 200 including data set generator 272 for creating data sets for one or more supervised models (e.g., models of capsules module 170, defect analysis module 180, and/or corrective action determiner module 190, etc.). Data set generator 272 may create data sets (e.g., data input 210, target output 220) using historical data. In some embodiments, a data set generator similar to data set generator 272 may be utilized to train an unsupervised machine learning model, e.g., target output 220 may not be generated by data set generator 272. For example, a machine learning model may be configured to perform clustering operations or outlier recognition, and such a model may be trained in an unsupervised manner.

Data set generator 272 may generate data sets to train, test, and validate a model. In some embodiments, data set generator 272 may generate data sets for a machine learning model. In some embodiments, data set generator 272 may generate data sets for training, testing, and/or validating a defect analysis model configured to predict defect root causes, and/or perform other operations associated with substrate defects. In some embodiments, data set generator 272 may generate data sets for training, testing, and/or validating a corrective action determine model configured to predict defect corrective actions and/or perform other operations associated with substrate defects.

The machine learning model is provided with set of defect data 264-1 and/or set of context data 250-1 as data input 210. The defect data may include measurements of one or more substrate defects, such as defect images, features extracted from defect images, defect spectral data, composition extracted from spectral data, etc. The context data may include data related to generation of substrate defects, such as hardware data, hardware maintenance history data, process recipe data, chamber condition data, etc. The machine learning model may be configured to accept defect and context data as input data and generate predictive data for correcting defect root causes as output data.

Data set generator 272 may be used to generate data for any type of machine learning model that takes as input defect and/or context data. Data set generator 272 may be used to generate data for a machine learning model that generates predicted metrology data of a substrate. Data set generator 272 may be used to generate data for a machine learning model configured to provide process control instructions. Data set generator 272 may be used to generate data for a machine learning model configured to identify a product anomaly and/or processing equipment fault. Data set generator 272 may be used to generate data for a machine learning model configured to predict defect root causes. Data set generator 272 may be used to generate data for a machine learning model configured to predict corrective actions for addressing root causes, etc.

In some embodiments, data set generator 272 generates a data set (e.g., training set, validating set, testing set) that includes one or more data inputs 210 (e.g., training input, validating input, testing input). Data inputs 210 may be provided to training engine, a validating engine, or testing engine (e.g., of capsules module 170, defect analysis module 180, and/or corrective action determiner module 190). The data set may be used to train, validate, or test the model (e.g., a model of capsules module 170, defect analysis module 180, and/or corrective action determiner module 190).

In some embodiments, data input 210 may include one or more sets of data. As an example, system 200 may produce sets of defect data that may include one or more of defect data from one or more types of metrology tools, combinations of defect data from one or more types of metrology tools, patterns from defect data from one or more analysis or extracted features of metrology data, or the like. As an example, system 200 may produce sets of historical defect data that may include one or more of metrology data of a group of dimensions of a device (e.g., include height and width of the device but not optical data or surface roughness, etc.), metrology data derived from one or more types of sensors, combination of metrology data derived from one or more types of sensors, patterns from metrology data, etc. Sets of data input 210 may include data describing different aspects of manufacturing, e.g., a combination of metrology data and sensor data, a combination of metrology data and manufacturing parameters, combinations of some metrology data, some manufacturing parameter data and some sensor data, etc.

In some embodiments, data set generator 272 may generate a first data input corresponding to a first set of defect data 264-1 to train, validate, or test a first machine learning model. Data set generator 272 may generate a second data input corresponding to a second set of historical defect data (e.g., a set of historical metrology data 264-2, not shown) to train, validate, or test a second machine learning model. Further sets of historical metrology data may further be utilized in generating further machine learning models. Any number of sets of historical defect data may be utilized in generating any number of machine learning models, up to a final set, set of historical defect data 264-N, N representing any target quantity of data sets, models, etc. Similarly, multiple sets (e.g., corresponding sets) of any other input data, including sets of context data 250-1, 250-2, . . . 205-N may be utilized in training a machine learning model.

In some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220. In some embodiments, data set generator 272 may generate data for training a machine learning model configured to output predicted defect root causes, defect analysis, and/or predicted corrective actions associated with correcting defect root causes, by outputting predictive defect data. For training such a model, data set generator 272 may generate target output data corresponding to the data input, e.g., output corrective action data 268. Data inputs 210 may also be referred to as “features,” “attributes,” or “information.” In some embodiments, data set generator 272 may provide the data set to a training engine, a validating engine, or a testing engine, where the data set is used to train, validate, or test the machine learning model (e.g., one of the machine learning models that are included in capsules module 170, defect analysis module 180, and/or corrective action determiner module 190, etc.).

Data inputs 210 to train, validate, or test a machine learning model may include information for a particular manufacturing chamber (e.g., for particular substrate manufacturing equipment). In some embodiments, data inputs 210 may include information for a specific type of manufacturing equipment, e.g., manufacturing equipment sharing specific characteristics. Data inputs 210 may include data associated with a device of a certain type, e.g., intended function, design, produced with a particular recipe, etc. Data inputs 210 may be associated with a target collection of input data, e.g., weight may be applied to various portions of input data to account for data reliability, availability, completeness, or the like.

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

FIG. 3 is a block diagram illustrating system 300 for generating output data (e.g., predictive data 168 of FIG. 1), according to some embodiments. In some embodiments, system 300 may be used in conjunction with one or more machine learning models configured to generate predictive defect data, such as root cause data, corrective action data, analysis data, etc. In some embodiments, system 300 may be used in conjunction with a machine learning model to determine a corrective action associated with manufacturing equipment. In some embodiments, system 300 may be used in conjunction with a machine learning model to determine a fault of manufacturing equipment. In some embodiments, system 300 may be used in conjunction with a machine learning model to cluster or classify substrate defects. In some embodiments, system 300 may be used in conjunction with a machine learning model to determine a corrective action for manufacturing equipment. System 300 may be used in conjunction with a machine learning model with a different function than those listed, associated with a manufacturing system.

At block 310, system 300 performs data partitioning (e.g., via a data set generator) of data to be used in training, validating, and/or testing a machine learning model. In some embodiments, training defect data 364 includes historical data, such as historical metrology data, historical context data, historical root cause data, historical classification data (e.g., classification of whether a product meets performance thresholds), historical microscopy image data, etc. Training data 364 may undergo data partitioning at block 310 to generate training set 302, validation set 304, and testing set 306. For example, the training set may be 60% of the training data, the validation set may be 20% of the training data, and the testing set may be 20% of the training defect data 364.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if training defect data 364 includes features extracted from metrology data, including 20 image features, and 10 manufacturing parameters (e.g., manufacturing parameters that correspond to the same processing runs(s) as the substrates depicted in the image data), the image feature data may be divided into a first set of features including image features 1-10 and a second set of features including image features 11-20. The manufacturing parameters may also be divided into sets, for instance a first set of manufacturing parameters including parameters 1-5, and a second set of manufacturing parameters including parameters 6-10. Either target input, target output, both, or neither may be divided into sets. Multiple models may be trained on different sets of data.

At block 312, system 300 performs model training (e.g., via a training engine) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item (e.g., a number of measured dimensions of a manufactured device, a cartoon picture of a manufactured device, etc.) to generate an output. The output may include, for example, a predicted defect root cause and/or a predicted corrective action. The output may be compared to a label of the training data item (e.g., a root cause labeled by a subject matter expert in association with defects of the historical training data, a corrective action labeled by a subject matter expert in association with defects of the historical training data).

Processing logic may then compare the generated output (e.g., predicted defect root cause, predicted defect corrective action) to the label (e.g., provided root cause in association with the input data, provided corrective action in association with the input data) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., image feature data from image features 1-10, metrology measurements 1-10, etc.) and to generate a second trained model using the second set of features in the training set (e.g., image feature data from image features 11-20, metrology measurements 11-20, etc.). In some embodiments, the first trained model and the second trained model may be combined to generate a third trained model (e.g., which may be a better predictor or synthetic data generator than the first or the second trained model on its own). In some embodiments, sets of features used in comparing models may overlap (e.g., first set of features being image feature data from image features 1-15 and second set of features being image feature data from image features 5-20). In some embodiments, hundreds of models may be generated including models with various permutations of features and combinations of models.

At block 314, system 300 performs model validation (e.g., via a validation engine) using the validation set 304. The system 300 may validate each of the trained models using a corresponding set of features of the validation set 304. For example, system 300 may validate the first trained model using the first set of features in the validation set (e.g., image feature data from image features 1-10 or metrology measurements 1-10) and the second trained model using the second set of features in the validation set (e.g., image feature data from image features 11-20 or metrology measurements 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via a selection engine) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via a testing engine) using testing set 306 to test selected model 308. System 300 may test, using the first set of features in the testing set (e.g., image feature data from image features 1-10), the first trained model to determine the first trained model meets a threshold accuracy. Determining whether the first trained model meets a threshold accuracy may be based on the first set of features of testing set 306. Responsive to accuracy of the selected model 308 not meeting the threshold accuracy, flow continues to block 312 where system 300 performs model training (e.g., retraining) using different training sets corresponding to different sets of features. Accuracy of selected model 308 may not meet threshold accuracy if selected model 308 is overly fit to the training set 302 and/or validation set 304. Accuracy of selected model 308 may not meet threshold accuracy if selected model 308 is not applicable to other data sets, including testing set 306. Training using different features may include training using data from different sensors, different manufacturing parameters, etc. Responsive to determining that selected model 308 has an accuracy that meets a threshold accuracy based on testing set 306, flow continues to block 320. In at least block 312, the model may learn patterns in the training data to make predictions. In block 318, the system 300 may apply the model on the remaining data (e.g., testing set 306) to test the predictions.

At block 320, system 300 uses the trained model (e.g., selected model 308) to receive current data 322 and determines (e.g., extracts), from the output of the trained model, predictive data 324. Current data 322 may be manufacturing parameters related to a process, operation, troubleshooting guide, or action of interest. Current data 322 may be manufacturing parameters related to a process under development, redevelopment, investigation, etc. Current data 322 may be metrology data indicative of defects of a substrate of interest. Current data 322 may be manufacturing parameters or hardware parameters (e.g., context data) in association with one or more substrate defects of interest. A corrective action associated with the manufacturing equipment 124 of FIG. 1 may be performed in view of predictive data 324. In some embodiments, current data 322 may correspond to the same types of features in the historical data used to train the machine learning model. In some embodiments, current data 322 corresponds to a subset of the types of features in historical data that are used to train selected model 308. For example, a machine learning model may be trained using a number of manufacturing parameters, and configured to generate output based on a subset of the manufacturing parameters.

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model, etc.

Generation of a new model may include providing additional training data 346. Generation of a new model may further include providing current data 322, e.g., data that has been used by the model to make predictions. In some embodiments, current data 322 when provided for generation of a new model may be labeled with an indication of an accuracy of predictions generated by the model based on current data 322. Additional training data 346 may be provided to model training 312 for generation of one or more new machine learning models, updating, retraining, and/or refining of selected model 308, etc.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, hardware configuration data, metrology data, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be performed, utilizing current data 322 and/or additional training data 346.

FIGS. 4A-B are flow diagrams of methods 400A-B associated with training and utilizing machine learning models, according to certain embodiments. Methods 400A-B may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-B may be performed, in part, by capsules module 170, defect analysis module 180, and/or corrective action determine module 190. Capsules module 170, defect analysis module 180, and/or corrective action determine module 190 may use method 400A to generate a data set to at least one of train, validate, or test one or more machine learning models, in accordance with embodiments of the disclosure. Method 400B may be performed by capsules module 170, defect analysis module 180, corrective action determine module 190, and/or client device 120. In some embodiments, provided is a non-transitory machine-readable storage medium storing instructions that when executed by a processing device (e.g., of capsules module 170, defect analysis module 180, and/or corrective action determine module 190, etc.) cause the processing device to perform one or more of methods 400A-B.

For simplicity of explanation, methods 400A-B are depicted and described as a series of operations. However, operations in accordance with this disclosure can occur in various orders and/or concurrently and with other operations not presented and described herein. Furthermore, not all illustrated operations may be performed to implement methods 400A-B in accordance with the disclosed subject matter. In addition, those skilled in the art will understand and appreciate that methods 400A-B could alternatively be represented as a series of interrelated states via a state diagram or events.

FIG. 4A is a flow diagram of a method 400A for generating a data set for a machine learning model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of hardware parameters, manufacturing parameters, metrology data, context data, defect data, troubleshooting guide data, etc. In some embodiments, the first data input may include a first set of features for types of data and a second data input may include a second set of features for types of data (e.g., as described with respect to FIG. 3). Input data may include historical data in some embodiments, such as historical defect data and/or historical context data, etc.

In some embodiments, at block 403, processing logic optionally generates a first target output for one or more of the data inputs (e.g., first data input). In some embodiments, the input includes one or more instances of defect data and context data and the target output is a root cause of one or more defects and/or a corrective action for the one or more defects. In some embodiments, the input includes data indicative of substrate defects and the target output is a root cause correction and/or a corrective action. In some embodiments, the first target output is predictive data. In some embodiments, no target output is generated (e.g., an unsupervised machine learning model capable of grouping or finding correlations in input data, rather than requiring target output to be provided). An example of unsupervised training may include a machine learning model configured to determine clustering or grouping of substrate defects predicted to be related to the same root cause and/or to the same corrective action.

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T to train, validate, and/or test a machine learning. In some embodiments, data set T is a training set and is provided to a training engine to perform the training. In some embodiments, data set T is a validation set and is provided to a validation engine to perform the validating. In some embodiments, data set T is a testing set and is provided to a testing engine to perform the testing.

In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model can be trained using a training engine, validated using a validating engine, and/or tested using a testing engine. The trained model may be implemented by capsules module 170, defect analysis module 180, and/or corrective action determine module 190 to generate predictive data 168 for performing signal processing, or for determining a corrective action associated with manufacturing equipment 124.

FIG. 4B is a flow diagram of a method 400B for generating and utilizing predicted corrective action data, according to some embodiments. At block 410 of method 400B, processing logic obtains defect data for a substrate processed in a substrate processing system. The defect data may include image features. The image features may be or include features of a defect image. The image feature may be generated by a trained machine learning model in some embodiments. Alternatively, the image feature may be generated based on performing image processing on an image. The defect data may include spectral data. The defect data may include defect composition data, which may be based on spectral data. The composition data may be generated by a physics-based model, a machine learning model, a physics-based model with output modified based on context data (e.g., process recipe data may be used to exclude one or more components determined based on spectral data, which are unlikely to be included in the defect). In some embodiments, the defect composition data is generated based on spectral analysis of a sample. The defect data may include defect spatial signature data. The defect spatial signature data may include a classification of a pattern of locations of related defects, e.g., of one substrate, related defects across multiple substrates, etc. In some embodiments, defect spatial signature data may be determined by a trained machine learning model. In some embodiments, defect spatial signature data is determined by performing image processing on an image. Defect data may include defect classification data. Defect classification data may be generated by a trained machine learning model. Alternatively, defect classification data may be input by a user or provided based on processing image data of defects using image processing techniques.

At block 420, process logic obtains context data associated with the substrate. The context data may include process chamber data associated with the substrate. The context data may include hardware component data associated with the process chamber. The context data may include process recipe data associated with the substrate (e.g., of one or more processes performed on the substrate by a process chamber). The context data may include chamber chemistry data and/or process chemistry data associated with the substrate.

At block 430, process logic optionally determines a project (e.g., a default troubleshooting project) including historical defect data for one or more prior substrates that approximately matches the defect data, historical context data for the one or more prior substrates, root causes of the historical defect data, and actions performed to identify the root causes of the historical defect data. In some embodiments, determining the project is performed responsive to a user selecting the project via a graphical user interface (GUI). The project may be selected (e.g., by the user) based on the similarity of the historical defect data to the current defect data (e.g., obtained at block 410). For example, the project may be determined because the historical defect data of the project substantially or approximately matches the current defect data. In some embodiments, a project is selected based on inputting the defect data and/or context data into one or more trained machine learning models and/or search engines, which may output one or more recommendations for projects that match or approximately match current data.

At block 440, process logic determines a troubleshooting guide associated with the defect data, the troubleshooting guide including a sequence of troubleshooting operations, each associated with one or more probably root causes for the defect data. In some embodiments, the troubleshooting guide is determined from a plurality of troubleshooting guides. In some embodiments, the troubleshooting guide(s) are associated with the selected project. In some embodiments, the process logic receives a selection of the troubleshooting guide. For example, a user may select the troubleshooting guide (e.g., via a GUI) from multiple troubleshooting guides. The troubleshooting guide may be determined based on the relevance of the troubleshooting guide to the defect data. For example, where the defect data indicates a problem with gas flow in a process chamber, a troubleshooting guide which is associated with gas flow problems may be selected. In some embodiments, a default troubleshooting guide may be selected. In some embodiments, a troubleshooting guide is selected based on inputting the defect data and/or context data into one or more trained machine learning models and/or search engines, which may output one or more recommendations for one or more troubleshooting guides.

At block 450, process logic determines a subset of context data based on the troubleshooting guide. Using the troubleshooting guide, the process logic can filter the context data. In some embodiments, the process logic determines the instances of context data that are relevant to the troubleshooting guide. For example, where the troubleshooting guide is for troubleshooting gas flow, etc., the process logic selects instances of context data associated with gas flow. The process logic may group the selected relevant context data into a subset of context data.

At block 460, process logic processes the defect data and the subset of context data using one or more trained machine learning models that output a predicted corrective action associated with a troubleshooting operation in the sequence of troubleshooting operations. In some embodiments, one or more trained machine learning models are used to predict the corrective action. One or more first trained machine learning models (e.g., one or more models of the defect analysis module 180, etc.) may use the defect data and the subset of context data to predict root cause data, and one or more second trained machine learning models (e.g., one or more models of the corrective action determiner module 190, etc.) may use the predicted root cause data to predict corrective action data. Alternatively, a single machine learning model may output predicted root cause data and predicted corrective action data. In an example, optionally, at block 462, the defect data and the subset of the context data are input into a first trained machine learning model. The first trained machine learning model may be trained to output a predicted root cause associated with the defect data and the context data (e.g., the subset of the context data). Optionally, at block 464, at least the predicted root cause (optionally together with the subset of context data and/or defect data) is input into a second trained machine learning model trained to output a predicted corrective action.

At block 470, process logic initiates the corrective action. In some embodiments, initiating the corrective action includes updating software (e.g., control software, etc.) for the substrate processing system to correct the defect. In some embodiments, initiating the corrective action includes initiating seasoning operations, initiating cleaning operations, initiating maintenance operations, scheduling maintenance or replacement of components, or the like. In some embodiments, the corrective action is initiated. Initiating the corrective action may include outputting an indication of the corrective action for display on a graphical user interface (GUI), such as for viewing by a user (e.g., an engineer or technician, etc.). In some embodiments, an alert indicative of the corrective action is provided to a user (e.g., via a GUI).

At block 480, process logic optionally performs feedback operations. The feedback operations may be directed at receiving input from one or more users or subject matter experts to improve operations of a defect root cause analysis system, model, or the like. Feedback operations may include prompting a user (e.g., via a user interface, such as a GUI of client device 120 of FIG. 1) to provide feedback based on output of the one or more trained machine learning models. Feedback operations may include obtaining user feedback. In some embodiments, feedback operations include determining whether the corrective action resolved a root cause of the defect data. Determining whether the corrective action resolved the root cause may be based on feedback provided by the user. Feedback operations may include determining, based on feedback provided by the user, whether to retrain at least one of the one or more trained machine learning models. Feedback operations may include retraining at least one of the one or more trained machine learning models. Feedback operations may include updating the troubleshooting guide based on whether the corrective action resolved the root cause of the defect data.

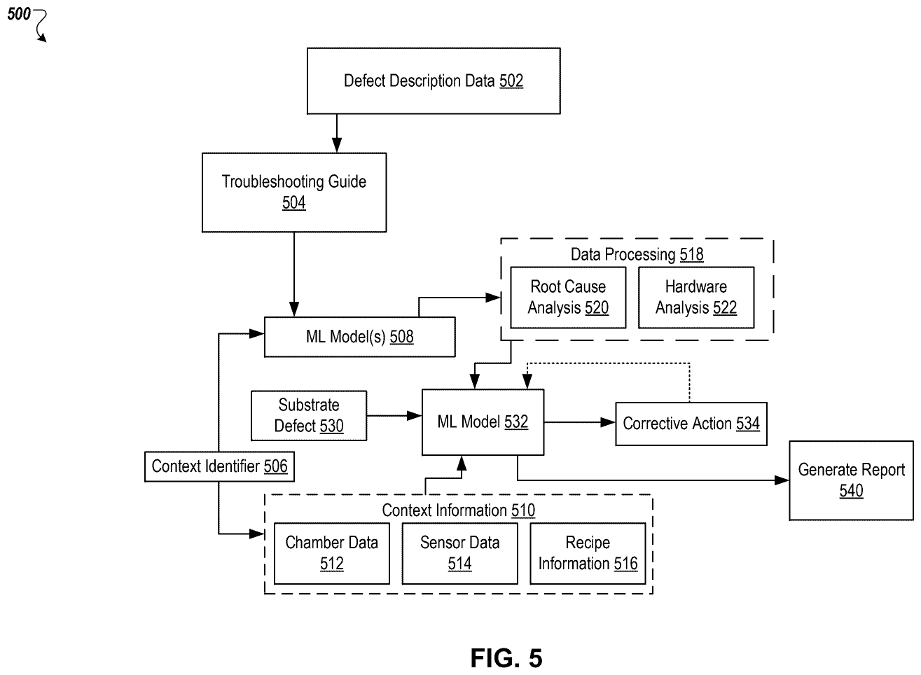

FIG. 5 depicts a data flow 500 in association with operation of a defect troubleshooting analysis system, according to some embodiments. In some embodiments, defect description data 502 is created. The defect description data 502 may be created by a user. The user may create a project (e.g., a defect troubleshooting project, etc.) and may enter a description of the substrate defect. Such description may include defect identifiers and/or other information as described herein. The defect description data 502 may include defect data and context data. In some embodiments, the defect description data 502 includes data indicative of a substrate defect, such as image data, composition data, spectral data, defect classification data, and/or other defect data etc. representative of one or more defects of one or more substrates. Such defect data may be generated by one or more metrology devices and stored in a data store in embodiments. Additionally, the defect description data 502 may include data indicative of processing parameters and/or settings, etc., such as process chamber data, hardware component data, process recipe data, and/or chamber chemistry data, etc.

The troubleshooting guide 504 may be selected from a library of troubleshooting guides based on relevance to the defect description data 502. For example, it may be determined that the troubleshooting guide 504 is relevant to the defect description data 502. In some embodiments, the troubleshooting guide 504 includes a sequence of operations for probable root causes of defects. The sequence of operations may outline a procedure to be implemented for correcting a defect. The defect description data 502 may be filtered based on the procedures in the troubleshooting guide 504. For example, where procedures in the troubleshooting guide 504 are aimed at diagnosing a temperature-related defect, the defect description data 502 may be filtered based on temperature-related data. The temperature-related data may be selected and grouped into a subset of data. In some embodiments, the context data included in the defect description data 502 is filtered based on the troubleshooting guide 504.

The filtered defect description data 502 and a context identifier 506 may be provided to one or more machine learning model(s) 508. The context identifier 506 may be associated with a project (e.g., a default troubleshooting project), such as a historical project including historical defect data for one or more prior substrates. The project may be determined (e.g., selected, etc.) based on a similarity of the historical defect data to the defect description data 502. The project may include historical context data for the one or more prior substrates, root causes of the historical defect data, and/or actions performed to identify the root causes. The context identifier 506 indicative of the project may be provided to the one or more machine learning model(s) 508 for referencing the project.

The one or more machine learning model(s) 508 may include a first trained machine learning model (e.g., of defect analysis module 180) for performing root cause analysis and a second trained machine learning model (e.g., of defect analysis module 180) for determining a predicted root cause of the defect. In some embodiments, output from the one or more machine learning model(s) 508 undergoes data processing 518. In some embodiments, root cause analysis 520 is performed to identify a potential root cause of the defect(s) indicated in the defect description data 502. One or more machine learning models (e.g., 508) may be used to perform root cause analysis 520. For example, a trained machine learning model may be used to process the defect description data 502 and/or context data to predict a probable root cause. In some embodiments, hardware analysis 522 is performed to analyze the substrate processing hardware, including the condition and/or state of the hardware, etc. One or more machine learning models may be used to perform hardware analysis 522.

The processed data (e.g., from data processing 518), data indicative of a substrate defect 530 (e.g., film data, imaging data, spectral data, etc.), and context information 510 may be input into a machine learning model 532. In some embodiments, a subset of the context information 510 is determined based on the troubleshooting guide 504 and input into the machine learning model 532. In some embodiments, context information 510 is contextual data (e.g., context data, etc.). Context information 510 may include chamber data 512, sensor data 514, and/or recipe information 516. Context information 510 may include data indicative of the context under which the substrate was processed, resulting in the substrate defect 530. Such information can be useful for determining the cause of the defect and/or a corrective action to mitigate the defect, etc.

The machine learning model 532 may output a predicted corrective action 534. The corrective action 534 may be an action to mitigate and/or correct for the substrate defect 530. A user may implement the recommended corrective action in an attempt to correct the cause of the defect. In some embodiments, user feedback is prompted to determine whether the predicted corrective action 534 resolves a root cause of the substrate defect 530. If the predicted corrective action 534 does not resolve the root cause, the predicted corrective action 534 may be provided as input to the machine learning model 532 for prediction of a new corrective action 534. If the predicted corrective action 534 does resolve the root cause, the corrective action 534 may be initiated for future production runs. The troubleshooting guide 504 may be updated based on whether the corrective action 534 resolved the root cause of the substrate defect 530.

In some embodiments, a report is generated (e.g., generate report 540) based on the data inputs and the predicted corrective action 534. The report may be indicative of the defect data (e.g., the defect description data 502), the context data (e.g., context information 510), the troubleshooting guide 504, and/or the corrective action 534. The report may include one or more slides describing the above information.

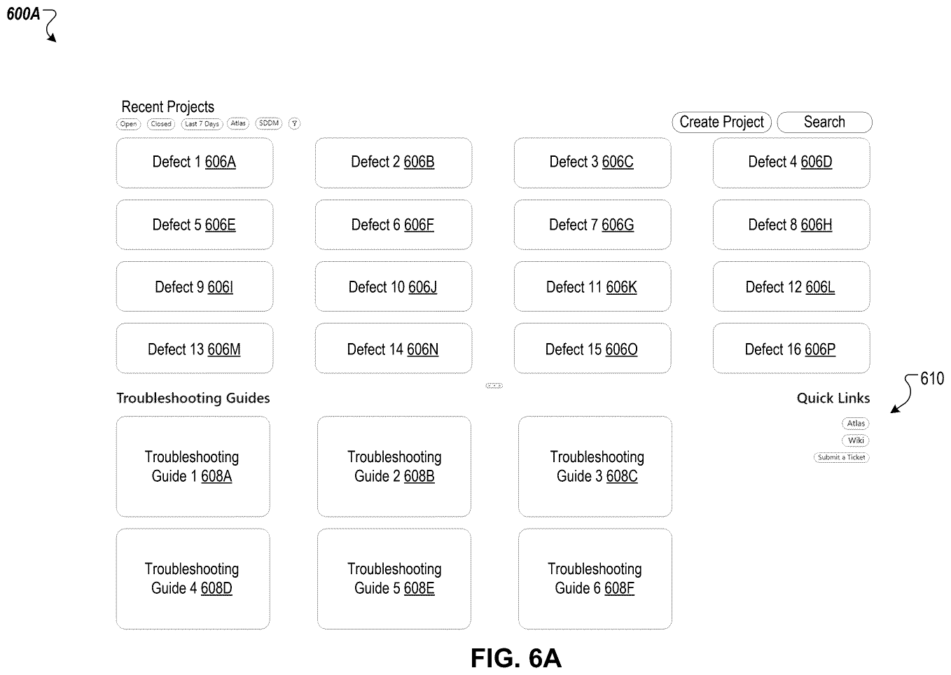

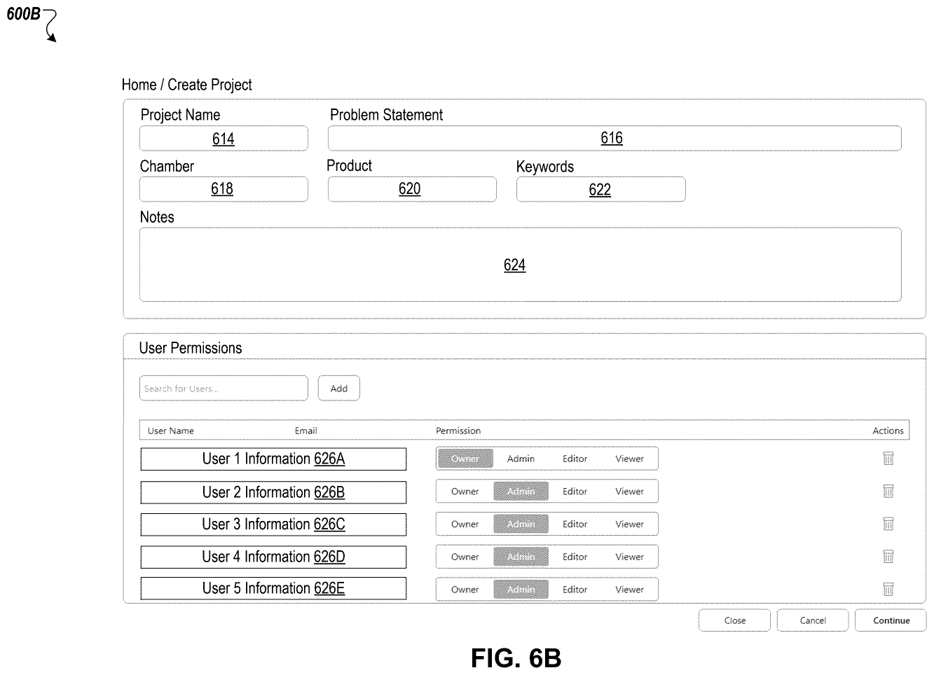

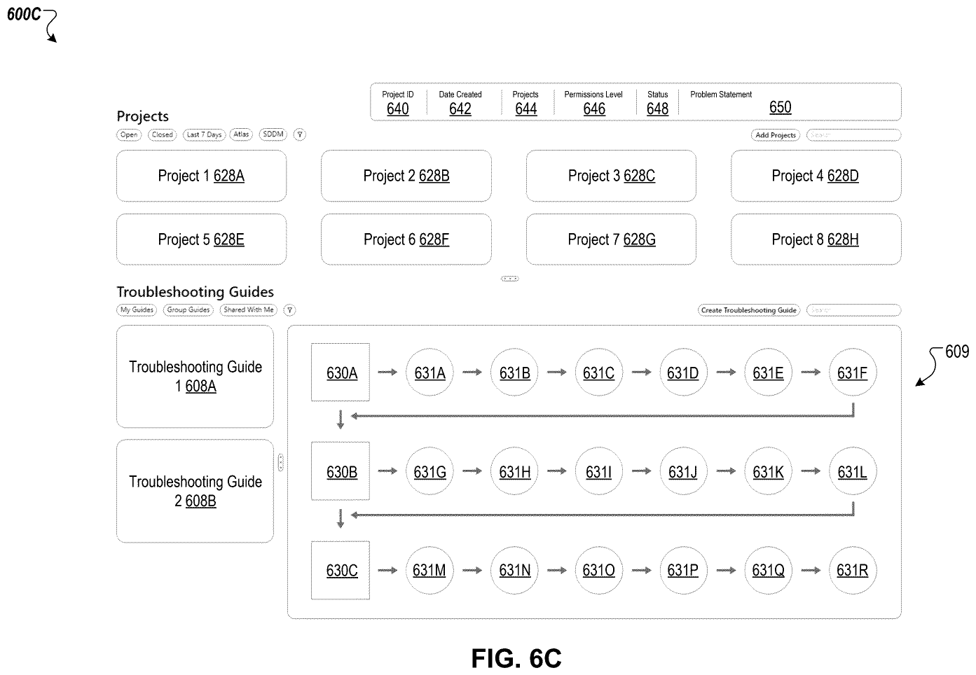

FIGS. 6A-C depict exemplary user interfaces, according to some embodiments. Each of the user interfaces depicted in FIGS. 6A-6C may allow for user input for performing one or more of the methods described herein.

Referring to FIG. 6A, a first example user interface 600A is shown. In some embodiments, user interface 600A is a “home page” for a defect troubleshooting widget as described herein. Multiple projects (e.g., defect troubleshooting projects) corresponding to past defects (e.g., defect 1 606A through defect 16 606P, etc.) may be shown. Multiple troubleshooting guides (e.g., troubleshooting guide 1 608A through troubleshooting guide 608F, etc.) may additionally be shown.

In some embodiments, a user can select a project from multiple defect projects or can select an option to create a new project. For example, a user can select any tile for projects corresponding to defect 1 606A through defect 16 606P. The user can click on the appropriate displayed tile to open the project. In some embodiments, the user can hover their cursor over a project tile (e.g., corresponding to any of defect 1 606A through defect 16 606P, etc.) to view a summary of the project. The summary may appear when the cursor hovers over the tile for more than a threshold duration of time. When a user selects the option to create a new project, user interface 600B may be shown.

In some embodiments, a user can select a troubleshooting guide from multiple troubleshooting guides. For example, a user can select any tile corresponding to troubleshooting guide 1 608A through troubleshooting guide 6 608F. The user can click on the appropriate displayed tile to open the troubleshooting guide. In some embodiments, the user can hover their cursor over a troubleshooting guide tile to view a summary of the troubleshooting guide. In some embodiments, various quick links 610 are provided near the right side of the user interface 600A.

Referring to FIG. 6B, a second example user interface 600B is shown. In some embodiments, user interface 600B is used for initiating a new defect troubleshooting project. The name of the project may be entered into field 614 and a problem statement for the project may be entered into field 650. The problem statement may be a short description for the project. An identification of a process chamber used for performing process operations on a substrate having a defect may be entered into field 618. An identification of the product embodied by the substrate may be entered into field 620. One or more keywords related to the project and/or the defect may be entered into field 622. Similarly, any notes may be entered into field 624. In some embodiments, textual data is entered into field 614-624. In some embodiments, interface 600B includes one or more features for managing user permissions associated with the project. For example, user information such as user 1 information 626A through user 5 information 626E may be displayed. Permissions for each of the users 1-5 may be selected such as by selecting a tile to the right of the presented user information corresponding to whether each of the users is an owner, an admin (e.g., administrator), an editor, or a viewer, etc. of the project.

Referring to FIG. 6C, a third example user interface 600C is shown. In some embodiments, tiles corresponding to defect troubleshooting projects (e.g., project 1 628A through project 8 628H, etc.) are shown. Information corresponding to the selected project may be shown in a banner near the top of the user interface 600C. Such information displayed may include a project ID 640, a date of creation 642, a project amount 644, a permissions level 646, a project status 648, and the problem statement 650. In some embodiments, tiles corresponding to troubleshooting guides are also shown. In some embodiments, an expanded view 609 of a selected troubleshooting guide is shown near the lower-right portion of the user interface 600C. In some embodiments, a troubleshooting guide includes a sequence of checks 631A-631R corresponding to possible defect causes 630A-630C. For each of the causes 630A-630C, a sequence of checks 631 may be performed. A check 631 may be a troubleshooting operation, such as for checking a specific parameter value or hardware component, etc. For example, for a possible defect cause 630A, a first check 631A is performed. If the first check 631A resolves the defect, no further checks need be performed. However, if the first check 631A does not resolve the defect, a second check 631B is performed, and so on. If the possible defect cause 630A is determined to not be the cause (e.g., such as after performing all the checks 631A-631F), then the checks corresponding to the possible defect cause 630B are performed (e.g., checks 631G-631L), and so on. The troubleshooting guide can be followed until the root cause of the substrate defect is resolved. In some embodiments, a user is presented with an option of creating a troubleshooting guide and/or modifying an existing troubleshooting guide.

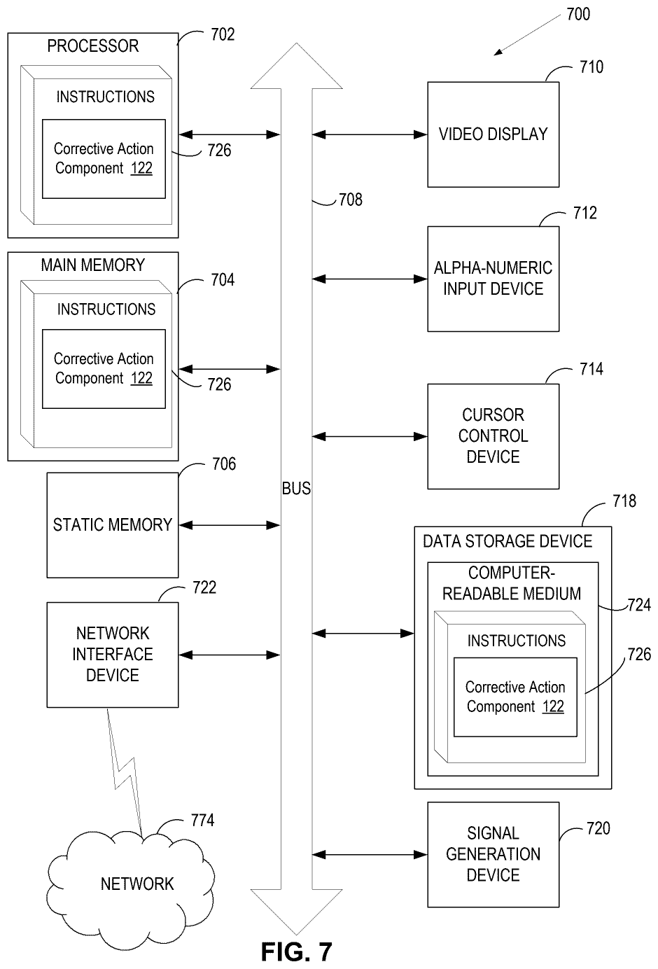

FIG. 7 is a block diagram illustrating a computer system 700, according to some embodiments. In some embodiments, computer system 700 may be connected (e.g., via a network, such as a Local Area Network (LAN), an intranet, an extranet, or the Internet) to other computer systems. Computer system 700 may operate in the capacity of a server or a client computer in a client-server environment, or as a peer computer in a peer-to-peer or distributed network environment. Computer system 700 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 may include a processing device 702, a volatile memory 704 (e.g., Random Access Memory (RAM)), a non-volatile memory 706 (e.g., Read-Only Memory (ROM) or Electrically-Erasable Programmable ROM (EEPROM)), and a data storage device 718, which may communicate with each other via a bus 708.

Processing device 702 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 700 may further include a network interface device 722 (e.g., coupled to network 774). Computer system 700 also may include a video display unit 710 (e.g., an LCD), an alphanumeric input device 712 (e.g., a keyboard), a cursor control device 714 (e.g., a mouse), and a signal generation device 720.

In some embodiments, data storage device 718 may include a non-transitory computer-readable storage medium 724 (e.g., non-transitory machine-readable medium, non-transitory machine-readable storage medium, or the like) on which may store instructions 726 encoding any one or more of the methods or functions described herein, including instructions encoding components of FIG. 1 (e.g., predictive component 114, corrective action component 122, etc.) and for implementing methods described herein.

Instructions 726 may also reside, completely or partially, within volatile memory 704 and/or within processing device 702 during execution thereof by computer system 700, hence, volatile memory 704 and processing device 702 may also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “processing,” “initiating,” “inputting,” “updating,” “prompting,” “training,” “retraining,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method, comprising:
obtaining, by a processing device, defect data for a substrate processed in a substrate processing system;
obtaining, by the processing device, context data associated with the substrate;
determining a troubleshooting guide associated with the defect data, the troubleshooting guide comprising a sequence of troubleshooting operations, each associated with one or more probable root causes for the defect data;
determining a subset of context data based on the troubleshooting guide;
processing the defect data and the subset of context data using one or more trained machine learning models that output a predicted corrective action associated with a troubleshooting operation in the sequence of troubleshooting operations; and
initiating the corrective action.

2. The method of claim 1, further comprising:
inputting the defect data and the subset of the context data into a first trained machine learning model of the one or more trained machine learning models, wherein the first trained machine learning model is trained to output a predicted root cause associated with the defect data and the context data; and
inputting at least the predicted root cause into a second trained machine learning model of the one or more trained machine learning models, wherein the second trained machine learning model is trained to output the predicted corrective action.

3. The method of claim 2, wherein the second trained machine learning model is trained with training input data comprising historical defect data and historical context data, and wherein the second trained machine learning model is trained with training output data comprising historical predicted root cause data.

4. The method of claim 1, further comprising:
receiving a selection of the troubleshooting guide from a plurality of troubleshooting guides.

5. The method of claim 1, wherein the troubleshooting guide comprises a plurality of corrective actions associated with a corresponding plurality of substrate defects.

6. The method of claim 1, further comprising:
determining a project comprising historical defect data for one or more prior substrates that approximately matches the defect data, historical context data for the one or more prior substrates, root causes of the historical defect data, and actions performed to identify the root causes of the historical defect data.

7. The method of claim 1, further comprising:
determining whether the corrective action resolved a root cause of the defect data; and
updating the troubleshooting guide based whether the corrective action resolved a root cause of the defect data.

8. The method of claim 1, further comprising:
generating a report indicative of at least one of the defect data, the context data, the troubleshooting guide, or the corrective action.

9. The method of claim 1, further comprising:
prompting a user to provide feedback based on output of the one or more trained machine learning models;
determining, based on the feedback, whether to retrain at least one of the one or more trained machine learning models; and
retraining at least one of the trained machine learning models.

10. The method of claim 1, wherein the defect data comprises one or more of:
image features of the substrate;
defect composition data;
defect spatial signature data; or
defect classification data generated by a third trained machine learning model.

11. The method of claim 1, wherein the context data comprises one or more of:
process chamber data in association with the substrate;
hardware component data in association with the process chamber;
process recipe data; or
chamber chemistry data.

12. The method of claim 1, wherein the corrective action comprises at least one of:
one or more seasoning operations of a process chamber;
one or more cleaning operations of the process chamber;
replacement of a component of the process chamber; or
one or more maintenance operations for the process chamber.

13. A non-transitory machine-readable storage medium storing instructions which, when executed by a processing device, cause the processing device to perform operations comprising:
obtaining defect data for a substrate processed in a substrate processing system;
obtaining context data associated with the substrate;
determining a troubleshooting guide associated with the defect data, the troubleshooting guide comprising a sequence of troubleshooting operations, each associated with one or more probable root causes for the defect data;
determining a subset of context data based on the troubleshooting guide;
processing the defect data and the subset of context data using one or more trained machine learning models that output a predicted corrective action associated with a troubleshooting operation in the sequence of troubleshooting operations; and
initiating the corrective action.

14. The non-transitory machine-readable storage medium of claim 13, wherein the processing device is to perform operations further comprising:
inputting the defect data and the subset of the context data into a first trained machine learning model of the one or more trained machine learning models, wherein the first trained machine learning model is trained to output a predicted root cause associated with the defect data and the context data; and
inputting at least the predicted root cause into a second trained machine learning model of the one or more trained machine learning models, wherein the second trained machine learning model is trained to output the predicted corrective action.

15. The non-transitory machine-readable storage medium of claim 13, wherein the processing device is to perform operations further comprising:
receiving a selection of the troubleshooting guide from a plurality of troubleshooting guides.

16. The non-transitory machine-readable storage medium of claim 13, wherein the processing device is to perform operations further comprising:
determining a project comprising historical defect data for one or more prior substrates that approximately matches the defect data, historical context data for the one or more prior substrates, root causes of the historical defect data, and actions performed to identify the root causes of the historical defect data.

17. A system, comprising memory and a processing device operatively coupled with the memory, wherein the processing device is configured to:
obtain defect data for a substrate processed in a substrate processing system;
obtain context data associated with the substrate;
determine a troubleshooting guide associated with the defect data, the troubleshooting guide comprising a sequence of troubleshooting operations, each associated with one or more probable root causes for the defect data;
determine a subset of context data based on the troubleshooting guide;
process the defect data and the subset of context data using one or more trained machine learning models that output a predicted corrective action associated with a troubleshooting operation in the sequence of troubleshooting operations; and
initiate the corrective action.

18. The system of claim 17, wherein the processing device is further configured to:
input the defect data and the subset of the context data into a first trained machine learning model of the one or more trained machine learning models, wherein the first trained machine learning model is trained to output a predicted root cause associated with the defect data and the context data; and
input at least the predicted root cause into a second trained machine learning model of the one or more trained machine learning models, wherein the second trained machine learning model is trained to output the predicted corrective action.

19. The system of claim 17, wherein the processing device is further configured to:
receive a selection of the troubleshooting guide from a plurality of troubleshooting guides.

20. The system of claim 17, wherein the processing device is further configured to:
determine a project comprising historical defect data for one or more prior substrates that approximately matches the defect data, historical context data for the one or more prior substrates, root causes of the historical defect data, and actions performed to identify the root causes of the historical defect data.
